(19) United States
(12) Patent Application Publication
(10) Pub. No.: US 2025/0101898 A1
(43) Pub. Date: Mar. 27, 2025

(54) ULTRA-COMPACT POST-PROCESSING SYSTEM, SUPERCHARGER ASSEMBLY AND ENGINE

(71) Applicants: WEICHAI POWER CO., LTD., Weifang, Shandong (CN); WEICHAI POWER EMISSION SOLUTIONS TECHNOLOGY CO., LTD., Weifang, Shandong (CN)

(72) Inventors: Weida LIU, Weifang, Shandong (CN); Cuiying HUO, Weifang, Shandong (CN); Biying ZHENG, Weifang, Shandong (CN)

(73) Assignees: WEICHAI POWER CO., LTD., Weifang, Shandong (CN); WEICHAI POWER EMISSION SOLUTIONS TECHNOLOGY CO., LTD., Weifang, Shandong (CN)

(21) Appl. No.: 18/725,781

(22) PCT Filed: Jan. 10, 2023
(86) PCT No.: PCT/CN2023/071532

§ 371 Date: Jun. 30, 2024

(30) Foreign Application Priority Data
Jan. 10, 2022 (CN) 202210022689.2

(51) Int. Cl. F01N 3/20; F01N 3/28; F01N 5/02

(52) U.S. Cl. CPC F01N 3/2066; F01N 3/2882; F01N 5/02; F01N 2340/06; F01N 2610/02

(57) ABSTRACT

An ultra-compact post-processing system, a supercharger assembly and an engine are provided. The ultra-compact post-processing system includes a mixer provided with an inlet joint to be connected to the supercharger body, a urea nozzle connected to the inlet joint, a shell provided outside a part of the mixer and provided with a gas outlet, and a catalytic disc provided in the shell between an outer periphery of the mixer and an inner wall of the shell and dividing an inner cavity of the shell into a mixing cavity and a gas-return cavity. The gas outlet of the shell is located at the gas-return cavity, and an outlet end of the mixer is provided with a mixing section that is located in the mixing cavity.

The present application claims the priority to Chinese Patent Application No. 202210022689.2, titled “ULTRA-COMPACT POST-PROCESSING SYSTEM, SUPERCHARGER ASSEMBLY AND ENGINE”, filed with the China National Intellectual Property Administration on Jan. 10, 2022, which is incorporated herein by reference in its entirety.

### FIELD

The present application relates to the technical field of vehicle engine, and in particular to an ultra-compact post-processing system, a supercharger assembly and an engine.

### BACKGROUND

A post-processing system refers to a catalytic converter that can convert pollutants in diesel engine exhaust gas into carbon dioxide, nitrogen, water, and other substances. This system includes a catalyst, an injection system, a mixer, a casing structure, etc.

With the continuous upgrading of emission regulations, the requirements for the diesel engine post-processing system are increasing, which brings technological challenges. The post-processing system and an emission control at an engine end need further technological upgrading to meet future National VI emission regulations in China.

The existing post-processing system is generally arranged on a vehicle chassis, that is, the exhaust comes out from a turbocharger at the engine end, flows through a long exhaust pipe (about 2 to 3 meters) and then enters the post-processing catalytic converter. Due to an influence of the length of the exhaust pipe, the exhaust pipe is exposed to the outside and can cause a heat dissipation of the exhaust gas, resulting in a temperature drop of 20 to 60° C., which therefore affects the conversion efficiency of the post-processing catalyst.

Therefore, it is desired for those skilled in the art to avoid or reduce the impact of the temperature drop caused by the exhaust pipe on the conversion efficiency of the catalyst.

### SUMMARY

In order to solve one or more technical problems occurred in the prior art or to provide a beneficial alternative, an ultra-compact post-processing system is provided in the present application, which can be arranged in front to avoid a temperature drop caused by the exhaust pipe, thus maximizing the conversion efficiency of the post-processing catalyst. In addition, a supercharger assembly that utilizes the ultra-compact post-processing system is further provided in the present application. In addition, an engine that utilizes the supercharger assembly is further provided in the present application.

An ultra-compact post-processing system is provided, including:
a mixer, which is provided with an inlet joint to be connected with a supercharger body;
a urea nozzle connected to the inlet joint;
a shell provided outside a part of an outer periphery of the mixer and provided with a gas outlet; and
a catalytic disc positioned inside the shell between the outer periphery of the mixer and an inner wall of the shell, and dividing an inner cavity of the shell into a mixing cavity and a gas-return cavity,
wherein the gas outlet of the shell is located at the gas-return cavity, and an outlet end of the mixer is provided with a mixing section that is located in the mixing cavity.

In an embodiment of the ultra-compact post-processing system, a gas-return passage is formed between the outer periphery of the mixer and the inner wall of the shell, and the gas outlet is arranged close to a tail end of the gas-return passage.

In an embodiment of the ultra-compact post-processing system, the shell is provided with a curved bowl bottom structure facing the outlet end of the mixer to guide a gas flow to return to the gas-return passage.

In an embodiment of the ultra-compact post-processing system, the catalytic disc is positioned at one end close to the inlet joint of the mixer.

In an embodiment of the ultra-compact post-processing system, the catalytic disc is sealed with the inner wall of the shell and an outer wall of the mixer, respectively.

In an embodiment of the ultra-compact post-processing system, the catalytic disc is a metal annular carrier or an annular ceramic cordierite carrier, which is coated with a copper-based molecular sieve SCR catalyst or a vanadium-based SCR catalyst.

In an embodiment of the ultra-compact post-processing system, the mixer comprises a pipe body and a perforated plate that is arranged perpendicular to an inner wall of the pipe body.

In an embodiment of the ultra-compact post-processing system, the perforated plate is arranged close to the inlet joint of the mixer.

A supercharger assembly is further provided in the present application, including a supercharger body and the ultra-compact post-processing system described above, wherein the supercharger body is provided with a supercharger outlet, which is connected to the inlet joint of the ultra-compact post-processing system.

An engine is further provided in the present application, including the supercharger assembly described above.

Due to adopting the technical solution above, an ultra-compact post-processing system and a supercharger assembly using the same according to the present application have the following beneficial effects:

(1) A novel ultra-compact post-processing system is provided in the present application, which can be integrated with the supercharger body. Since the exhaust pipe is omitted, the temperature of the exhaust gas does not drop through the exhaust pipe, and thus the temperature loss of the exhaust gas is minimized, fully utilizing the exhaust gas temperature to provide favorable reaction conditions for use of the subsequent catalyst, and improving the conversion efficiency of the post-processing system.

(2) The internal cavity of the shell is divided into a mixing cavity and a gas-return cavity by the catalytic disc in the present application. The exhaust gas discharged into the mixing cavity ensures a full reaction with the urea spray. Then, the exhaust gas coming from the mixing cavity passes through the catalytic disc into the gas-return cavity. When the exhaust gas passes through the catalytic disc, CO and NOx in the exhaust gas are converted into CO₂, N₂, and H₂O, finishing the post-processing of the exhaust gas. The catalytic disc has an annular structure and is arranged outside of the mixer, which effectively utilizes space. The exhaust gas temperature in the mixer can continuously heat the catalytic disc provided on the outer periphery of the mixer, significantly addressing the problem of a low catalytic reaction conversion efficiency caused by the temperature drop. Furthermore, the mixing cavity and the gas-return cavity, both enclosing the mixer externally, also act as thermal insulators, which reduce heat loss during the exhaust gas discharging process, ensuring a temperature stability during the catalytic process, and thereby improving the conversion efficiency of the post-processing system.

(3) The invention optimizes the flow direction of the exhaust gas. Compared with the conventional emission in a linear path, the present application uses an emission in a fold-back path, reducing the overall length of the post-processing system, achieving high integration, with a relatively lower heat dissipation area and a less heat loss, which can accelerate the catalytic effect.

(4) The mixer in the present application includes a mixing section located at the outlet end, and the mixing section is arranged in the mixing cavity behind the catalytic disc, which can length the mixing path and ensure a fully mixing, improving the urea uniformity, and forming a preheating passage to the catalytic disc, and thus reducing the temperature drop and enhancing the conversion efficiency.

(5) The present application provides a tightly-coupled post-processing mixer which makes full use of space and improves the urea mixing uniformity. The mixer includes a perforated plate, a pipe body with a certain length, and a mixing section, maximizing the mixing distance for the urea and the exhaust gas. A certain number of holes with a certain diameter are provided on the perforated plate to improve the mixing efficiency, ensuring the fully mixing and reducing the risk of crystallization.

### BRIEF DESCRIPTION OF THE DRAWINGS

The accompanying drawings are provided to facilitate the understanding of the present application and form a part of this application. The illustrative embodiments and the descriptions thereof are used to explain the present application and do not constitute an improper limitation to the present application. In the drawings:

FIG. 1 is a schematic structural view of an ultra-compact post-processing system according to an embodiment of the present application.

FIG. 2 is a schematic structural view of a supercharger assembly according to an embodiment of the present application.

### NUMERAL REFERENCES

100 post-processing system, 110 mixer, 111 swirl vane, 112 pipe body, 113 perforated plate, 120 urea nozzle, 130 shell, 131 gas outlet, 140 catalytic disc, 150 mixing cavity, 160 gas-return cavity, 200 supercharger body.

### DETAILED DESCRIPTION OF THE EMBODIMENTS

In order to further illustrate the overall concept of the present application, a detailed explanation will be provided below in conjunction with the accompanying drawings as examples.

It should be noted that while the following description describe many specific details to facilitate a comprehensive understanding of the application, the present application can also be implemented in ways different from those described herein. Therefore, the protection scope of the present application is not limited by the specific embodiments described below.

Furthermore, in the description of the present application, it should be understood that terms such as “center”, “up”, “down”, “front”, “rear”, “left”, “right”, “vertical”, “horizontal”, “top”, “bottom”, “inner”, “outer”, “axial”, “radial”, “circumferential”, and others indicating an orientation or a positional relationship are based on the orientation or positional relationship shown in the accompanying drawings. These terms are merely used to facilitate the description of the present application and simplify the description, which do not indicate or imply that the devices or components referred to must have specific orientations, be constructed and operated in specific orientations, and should not be understood as limiting the present application.

In the present application, unless otherwise clearly specified and limited, terms such as “installation” “connection”, “attachment”, “fixation”, and the like should be broadly construed. For example, it can be a fixed connection, a detachable connection, or formed integrally, it can be a direct connection, or an indirect connection through an intervening part, or it can be an interconnection within two components or a mutual interaction between two components. If it is specified as a direct connection, it means that the two components being connected are not connected through an intermediate structure, but are directly connected by a connecting structure to form a whole. Those skilled in the art can understand the specific meanings of the above terms in the present application according to specific circumstances.

In the present application, unless otherwise clearly specified and limited, the first feature being “on” or “under” the second feature can involve direct contact between the first and second features, or indirect contact through an intermediate medium. In the context of this specification, terms such as “one embodiment”, “some embodiments”, “example,” “specific example”, or “some examples” indicate that the specific features, structures, materials, or characteristics described in conjunction with that embodiment or example are included in at least one embodiment or example of the present application. In the specification, the illustrative descriptions of the above terms do not necessarily refer to the same embodiment or example. Moreover, the specific features, structures, materials, or characteristics described can be appropriately combined in any one or more embodiments or examples.

The solutions are described as follows.

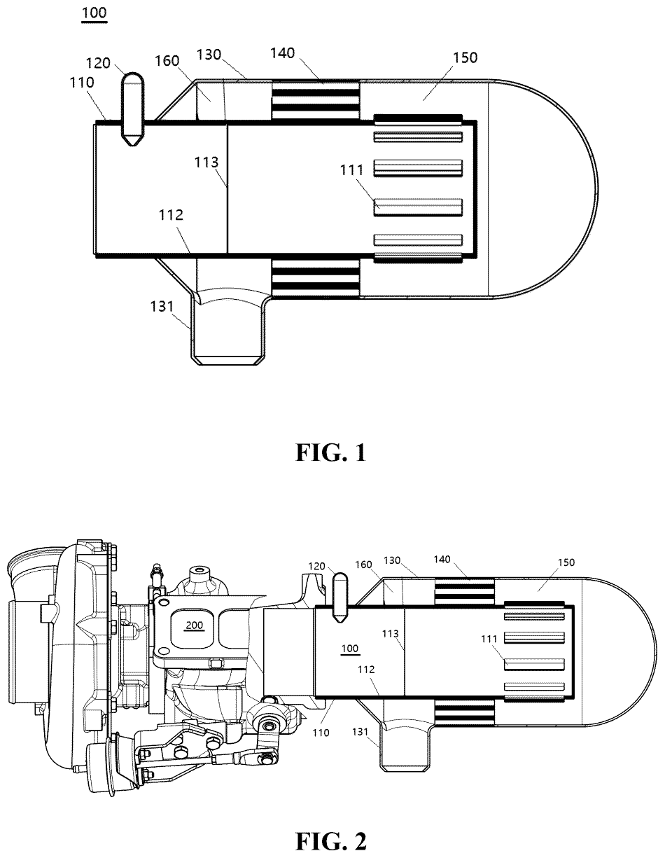

Referring to FIGS. 1 and 2, an ultra-compact post-processing system 100 is provided in the present application, which includes a mixer 110, a urea nozzle 120, a shell 130, and a catalytic disc 140. The urea nozzle 120 is configured to be connected to an external urea injection system, which provides a urea source for the selective catalytic reduction technology. The main components of the selective catalytic reduction system include a urea pump, urea nozzle 120, a catalytic reduction converter, a nitrogen oxide sensor, a temperature sensor, urea lines, a urea tank and so on. The basic working principle thereof is as follows: according to the operating conditions of the engine and other relevant factors, the diesel engine sends an instruction to the urea pump to inject urea; the urea pump draws a urea solution from the urea tank and sprays it into an exhaust pipe through a nozzle; and in the exhaust pipe, the urea solution is converted into ammonia, which transforms nitrogen oxides into nitrogen and water. The urea droplets are uniformly sprayed through the urea nozzle 120, allowing for fully mixing with the tail gas or exhaust gas.

The mixer 110 is a component that atomizes, breaks down and mixes the urea aqueous solution sprayed through the urea nozzle 120 with the diesel engine exhaust. The mixer 110 has an inlet end and an outlet end. The inlet end is provided with an inlet joint connected to the supercharger body 200. The exhaust gas discharged out of the supercharger body 200 enters the mixer 110 through the inlet joint, and comes into contact with and mixes with the urea spray. In FIG. 1, the left end of the mixer 110 represents the inlet end.

The shell 130 is arranged outside of a part of the mixer 110 and has a gas outlet 131. Specifically, the shell 130 is arranged outside of the outlet end of the mixer 110 opposite to the inlet end. The mixer 110 is exposed to the outside only at or near the inlet end, at least including the inlet joint for ease of connection with the supercharger. The rest part of the mixer 110 extends into the shell 130 to form a mixing path. In other words, the portion of the mixer 110 close to the inlet end, especially the inlet joint, is exposed outside the shell 130, whereas the rest portion of the mixer 110 is located inside the shell 130, forming a relatively enclosed space between the mixer and the shell 130. This relatively enclosed space is in communication with the outside through the gas outlet 131 of the shell 130. As shown in FIG. 1, the urea nozzle 120 is also exposed outside the shell 130, facilitating a connection with the relevant components such as the urea pump.

The catalytic disc 140 is positioned inside the shell 130, arranged between the out circumference of the mixer 110 and the inner wall of the shell 130. The catalytic disc 140 divides an inner cavity of the shell 130 into a mixing cavity 150 and a gas-return cavity 160. The mixing cavity 150 is closer to the outlet end of the mixer 110 than the gas-return cavity 160, and the outlet end of the mixer 110 is in communication to the gas-return cavity 160. It can be understood that the mixing cavity 150 and the gas-return cavity 160 here refer to the relatively enclosed space formed between the shell 130 and the mixer 110 as described above, and are divided by the catalytic disc 140. After being mixed with the urea spray, the exhaust gas is discharged from the outlet end of the mixer 110 into the mixing cavity 150, and then enters the catalytic disc 140 to be catalyzed so as to accelerate the reduction of the exhaust gas (especially sulfur dioxide and other harmful gas) and then flows into the gas-return cavity 160.

The gas outlet 131 of the shell 130 is located at the gas-return cavity 160, and the gas entering the gas-return cavity 160 is discharged from the gas outlet 131.

In this embodiment, the outlet end of the mixer 110 is provided with a mixing section, which is located in the mixing cavity 150.

The existing post-processing system is arranged on the vehicle chassis, and the exhaust gas coming from the engine-side supercharger has to travel through a long exhaust pipe before entering the post-processing system for mixing and catalysis. During this stage of passing through the exhaust pipe, there is a temperature drop of 20° C. to 60° C. due to exposure of the pipe. The conversion efficiency of the catalytic is also affected due to a significant temperature drop during the post-processing catalytic progress. A novel ultra-compact post-processing system 100 provided in the present embodiment can be integrated with the supercharger body 200. Since the exhaust pipe is omitted, the temperature of the exhaust gas is no longer dissipated from the exhaust pipe, so that the temperature loss of exhaust gas is effectively reduced and the exhaust gas temperature can be fully utilized to provide a favorable reaction condition for the subsequent catalyst, thereby improving the conversion efficiency of the post-processing system 100. In this embodiment, a catalytic disc 140 is used to divide the inner cavity of the shell 130 into the mixing cavity 150 and the gas-return cavity 160. The exhaust gas is discharged into the mixing cavity 150, which ensures a full reaction of the exhaust gas with the urea spray. Then, the exhaust gas enters the gas-return cavity 160 from the mixing cavity 150 through the catalytic disc 140. When the exhaust gas passes through the catalytic disc 140, CO and NOx in the exhaust gas are converted into CO₂, N₂, and H₂O, completing the post processing of the exhaust gas.

The catalytic disc 140 has a ring-shaped structure and is disposed on the outer side of the mixer 110, fully utilizing the space. The exhaust gas temperature in the mixer 110 can function to continuously heat the catalytic disc 140 disposed on the outer periphery of the mixer 110, effectively solving the problem of low catalytic reaction conversion efficiency caused by the temperature drop. The shortened length of the entire post-processing system 100 also reduces temperature loss during the mixing process of the urea spray and the exhaust gas. It is less likely for the urea spray to crystallize at a high temperature, which further increases the service life of the entire post-processing system 100.

In addition, since the mixing cavity 150 and the gas-return cavity 160 both externally enclose the mixer 110, they also act as heat insulators, which reduce heat loss in the exhaust gas discharging process and thus ensure the temperature stability in the catalytic process, thereby improving the conversion efficiency of the post-processing system 100. Furthermore, in this embodiment, the flow direction of the exhaust gas is optimized. Compared to the conventional emission in a linear path, this embodiment uses a fold-back path for emission, reducing the overall length of the entire post-processing system 100, achieving a high integration with a relatively less heat dissipation area and a less heat loss, which can accelerate the catalytic effect.

More importantly, since the mixing section is arranged in the mixing cavity 150 behind the catalytic disc 140 in this embodiment, the mixing path can be extended, which ensures fully mixing of the urea spray and the exhaust gas, improving the urea uniformity. Compared with a direct mixing and catalysis, the catalytic disc 140 is positioned at the front end of the mixing cavity 150, that is, the catalytic disc 140 is closer to the inlet end of the mixer 110 than the mixing cavity 150. This arrangement prevents the insufficient mixture of the urea spray and the exhaust gas from directly entering the catalytic disc 140 due to inertia, which is not conducive to the full reaction. That is, the catalytic disc 140 is located at the front end of the mixing cavity 150, and the urea spray and the exhaust gas return to the catalytic disc 140 only after being fully mixed, thereby achieving a higher mixing efficiency and forming a preheating passage to the catalytic disc 140, and thus reducing temperature drop and improving the conversion efficiency. Moreover, the catalytic disc 140 is positioned at the middle of the mixer 110, occupying a less space, and thus the mixture of the urea spray and the exhaust gas, which is not subject to a turbulent in the mixing section, has a less heat loss, facilitating preheating the catalytic disc 140 and ensuring the catalytic efficiency.

The specific form and position of the urea nozzle are not limited in the present application. In one embodiment, as shown in FIG. 1, the urea nozzle 120 is arranged perpendicular to the inlet joint of the mixer 110 and extends radially into the inlet joint of the mixer 110. When the exhaust gas passes through the outlet of the supercharger body 200 and enters the mixer 110, the gas pressure is relatively high, which can enhance the mixing effect with the urea spray.

The structural form of the mixer 110 is not limited in the present application. In one embodiment, as shown in FIG. 1, the mixer 110 has a straight cylindrical structure with the same diameter at the inlet and outlet ends, which facilitates assembly and volume control, making the whole machine more compact.

Referring to FIG. 1, in order to improve the conversion efficiency of the catalytic disc 140, a gas-return passage is formed between the outer periphery of the mixer 110 and the inner wall of the shell 130. The gas outlet 131 is arranged close to a tail end of the gas-return passage, i.e., the gas outlet 131 is arranged relatively close to the inlet end of the mixer 110. The tail end of the gas-return passage is close to the inlet joint of the mixer 110, so that the gas-return passage encloses most of the mixer 110, with only the inlet joint portion of the mixer 110 being exposed to the outside, which minimizes the temperature loss of the mixer 110. Moreover, since the mixture of the exhaust gas and the urea spray in the gas-return passage also has a certain temperature, which can realize a heat insulation for the exhaust gas subsequently entering from the inlet joint, and thus further reduces the temperature loss and provides favorable reaction conditions for the fully mixing of the subsequent exhaust gas and the urea spray and for the use of the catalyst, thereby improving the conversion efficiency of the post-processing system 100.

In order to further achieve a compactness of the post-processing mixer 110, in one embodiment, as shown in FIG. 1, the gas-return passage is arranged parallel to the gas flow direction of the mixer 110.

The specific structure of the mixing section is not limited in the present application, and it can adopt but is not limited to any one of the following specific embodiments:

### First Embodiment

As shown in FIG. 1, the mixing section includes a mixing pipe and swirl holes arranged in a circumferential direction of the mixing pipe, and swirl vanes 111 with a certain opening angle is provided on each swirl hole. The swirl vanes 111 are distributed circumferentially around the swirl pipe and are configured to generate a strong rotating gas flow. The axial end of the mixing pipe is open, which is in cooperation with the swirl holes opened circumferentially to divide the gas flow into two parts: one part flows out from the circumferential swirl holes, and the other part flows out from the axial opening. The two parts of gas flow facilitate forming turbulence, enhancing the mixing efficiency of the urea spray and the exhaust gas.

### Second Embodiment

In another embodiment not shown, the mixing section includes a mixing pipe and multiple axial flow fan blades arranged inside the mixing pipe. The axial end of the mixing pipe is open, and the mixed gas flow of the urea spray and the exhaust gas is guided by the axial flow fan blades, thereby improving the mixing efficiency of the urea spray and the exhaust gas.

Furthermore, in order to improve the catalytic efficiency and accelerate the return rate of the exhaust gas and the urea spray, the shell 130 has a curved bowl bottom facing the outlet end of the mixer 110 to guide the gas flow to return to the gas-return passage. Specifically, the curved bowl bottom of the shell 130 is semi-circular in shape. After flowing out from the axial opening of the mixer 110, the mixture of the urea spray and the exhaust gas rushes toward the curved bowl bottom. By a curved surface of the curved bowl bottom, the gas can be guided to flow back and to the catalytic disc 140, improving the return efficiency and facilitating a quick gas discharging. Combined with the previous embodiments, the returned gas flow can form turbulence with the gas flowing out radially from the swirl holes, thereby improving the mixing efficiency of the urea spray and the exhaust gas.

In one embodiment, as shown in FIG. 1, the catalytic disc 140 is arranged close to the inlet joint of the mixer 110. Considering the heat dissipation of the exhaust gas as a function of the length of the gas flow passage, disposing the catalytic disc 140 close to the inlet joint of the mixer 110 allows the catalytic reaction to occur at the position of minimal heat dissipation. When entering the mixer 110 through the inlet joint, the exhaust gas and the urea spray can heat the catalytic disc 140. However, if the catalytic disc 140 is positioned further away from the inlet joint, there is still further loss of heat. In this embodiment, the gas-return cavity 160 is defined by the shell 130 at the rear end of the catalytic disc 140, allowing the exhaust gas and the urea spray to be feed from the inlet joint to the catalytic disc 140 with minimal heat loss. When flowing inside the mixer 110, the exhaust gas and the urea spray continuously heat the catalytic disc 140, thereby improving the catalytic efficiency and the conversion efficiency.

In one embodiment, the catalytic disc 140 is sealed with the inner wall of the shell 130 and the outer wall of the mixer 110, respectively. By sealing the catalytic disc 140 with the inner wall of the shell 130 and the outer wall of the mixer 110, the mixture of the exhaust gas and the urea spray entirely passes through the catalytic disc 140, improving the catalytic efficiency.

In one embodiment, the catalytic disc 140 is a metal annular carrier or an annular ceramic cordierite carrier, which can adapt to a long-term high-temperature working environment, providing better carrier stability. The carrier may have a flat structure or a honeycomb structure and is coated with a copper-based molecular sieve SCR catalyst or a vanadium-based SCR catalyst coating.

The copper-based molecular sieve SCR catalyst exhibits an excellent catalytic effect on NOx, producing a large amount of N₂O. The vanadium-based SCR catalyst coating can gradually enhance a catalytic performance with increasing temperature under the high-temperature condition, exhibiting a better heat resistance property.

In one embodiment, as shown in FIG. 1, the mixer 110 includes a pipe body 112 and a perforated plate 113 that is arranged perpendicular to an inner wall of the pipe body 112. The perforated plate 113 can, one the one hand, implement a muffling effect to reduce operational noise and, on the other hand, improve a fragmentation effect of the urea spray. The perforated plate 113 is provided with uniformly distributed through-holes, which can guide the gas to flow out evenly according to the arrangement of the through-holes, facilitating the uniform mixing. The specific arrangement of the holes on the perforated plate 113 is not limited, but they are preferably arranged in an array, for example, in a radial distribution around the center of the perforated plate 113. The diameter and the distribution of the holes may be adjusted and designed based on a fluid simulation calculation to optimize the mixing effect.

In one embodiment, as shown in FIG. 1, the perforated plate 113 is arranged close to the inlet joint. By placing the perforated plate 113 close to the inlet joint, it can guide flow of the exhaust gas and the urea spray earlier, disperse the mixture, and preheat the catalytic disc 140 located outside of the middle section of the mixer 110.

Referring to FIG. 2, in one embodiment of the present application, a supercharger assembly is also provided. The supercharger assembly includes a supercharger body 200 and the aforementioned ultra-compact post-processing system 100. The supercharger body 200 is provided with a supercharger outlet, which is connected to the inlet joint of the ultra-compact post-processing system 100. The supercharger assembly in this embodiment also has all the aforementioned technical effects brought about by the ultra-compact post-processing system 100 in the aforementioned embodiment, which will not be repeated here.

The operation of the present application is as follows:

The engine exhaust gas is discharged from the supercharger body and directly enters the post-processing inlet. Urea is sprayed into the inlet pipe through the urea nozzle. The urea and the exhaust gas enter the mixer and are premixed through the perforated plate. After passing through a section of pipe, the mixture enters the annular catalyst through the swirl vane structure at the rear end of the mixer to perform SCR reaction so as to remove NOx from the exhaust gas, and then enters the subsequent exhaust pipe through the gas outlet.

The post-processing system of the present application is integrated with the supercharger, having a compact structure that maximizes the utilization of the space of the engine body. The post-processing system is tightly coupled to the supercharger as much as possible to minimize the exhaust gas temperature loss and enhance catalyst conversion efficiency. The catalyst is a metal annular carrier or an annular ceramic cordierite carrier, coated with a copper-based molecular sieve SCR catalyst or a vanadium-based SCR catalyst, which converts NOx in the exhaust gas into N₂ and H₂O using NH₃ as a reducing agent.

In one embodiment of the present application, an engine is also provided, including the aforementioned supercharger assembly. The engine in this embodiment also has all the aforementioned technical effects brought about by the supercharger assembly in the aforementioned embodiment, which will not be repeated here.

Those skilled in the art will understand that the engine disclosed in the embodiments can also be applied to a vehicle, namely a vehicle including the aforementioned engine. The vehicle in this embodiment also possesses all the aforementioned technical effects brought about by the engine in the aforementioned embodiment, which will not be repeated here.

It should be noted that, the above embodiments are only intended to describe the present application, and not for limiting the technical solutions described in the present application. Although the present application has been described in detail with reference to the above embodiments, it should be understood by those skilled in the art that, modifications or equivalent substitutions may be made to the present application by those skilled in the art, and any technical solutions and improvements thereof without departing from the spirit and the scope of the present application are deemed to fall into the scope of the claims of the present application.

1. An ultra-compact post-processing system, comprising:
a mixer, which is provided with an inlet joint to be connected with a supercharger body;
a urea nozzle connected to the inlet joint;
a shell provided outside a part of the mixer and provided with a gas outlet; and
a catalytic disc, wherein
the catalytic disc is positioned inside the shell, arranged between an outer periphery of the mixer and an inner wall of the shell, and divides an inner cavity of the shell into a mixing cavity and a gas-return cavity, and
the gas outlet of the shell is located at the gas-return cavity, and an outlet end of the mixer is provided with a mixing section that is located in the mixing cavity.

2. The ultra-compact post-processing system according to claim 1, wherein
a gas-return passage is formed between the outer periphery of the mixer and the inner wall of the shell, and the gas outlet is arranged close to a tail end of the gas-return passage.

3. The ultra-compact post-processing system according to claim 2, wherein
the shell is provided with a curved bowl bottom facing the outlet end of the mixer and configured to guide a gas to flow back to the gas-return passage.

4. The ultra-compact post-processing system according to claim 1, wherein
the catalytic disc is positioned close to the inlet joint of the mixer.

5. The ultra-compact post-processing system according to claim 1, wherein
the catalytic disc is sealed with the inner wall of the shell and an outer wall of the mixer.

6. The ultra-compact post-processing system according to claim 1, wherein
the catalytic disc is a metal annular carrier or an annular ceramic cordierite carrier, which is coated with a copper-based molecular sieve SCR catalyst or a vanadium-based SCR catalyst.

7. The ultra-compact post-processing system according to claim 1, wherein
the mixer comprises a pipe body and a perforated plate that is arranged perpendicular to an inner wall of the pipe body.

8. The ultra-compact post-processing system according to claim 7, wherein
the perforated plate is arranged close to the inlet joint of the mixer.

9. A supercharger assembly, comprising a supercharger body and an ultra-compact post-processing system, wherein
the ultra-compact post-processing system comprises:
a mixer, which is provided with an inlet joint to be connected with a supercharger body;
a urea nozzle connected to the inlet joint;
a shell provided outside a part of the mixer and provided with a gas outlet; and
a catalytic disc, wherein
the catalytic disc is positioned inside the shell, arranged between an outer periphery of the mixer and an inner wall of the shell, and divides an inner cavity of the shell into a mixing cavity and a gas-return cavity,
the gas outlet of the shell is located at the gas-return cavity, and an outlet end of the mixer is provided with a mixing section that is located in the mixing cavity, and
the supercharger body is provided with a supercharger outlet, which is connected to the inlet joint of the ultra-compact post-processing system.

10. An engine, comprising the supercharger assembly according to claim 9.

11. The supercharger assembly according to claim 9, wherein
a gas-return passage is formed between the outer periphery of the mixer and the inner wall of the shell, and the gas outlet is arranged close to a tail end of the gas-return passage.

12. The supercharger assembly according to claim 11, wherein
the shell is provided with a curved bowl bottom facing the outlet end of the mixer and configured to guide a gas to flow back to the gas-return passage.

13. The supercharger assembly according to claim 9, wherein
the catalytic disc is positioned close to the inlet joint of the mixer.

14. The supercharger assembly according to claim 9, wherein
the catalytic disc is sealed with the inner wall of the shell and an outer wall of the mixer.

15. The supercharger assembly according to claim 9, wherein
the catalytic disc is a metal annular carrier or an annular ceramic cordierite carrier, which is coated with a copper-based molecular sieve SCR catalyst or a vanadium-based SCR catalyst.

16. The supercharger assembly according to claim 9, wherein
the mixer comprises a pipe body and a perforated plate that is arranged perpendicular to an inner wall of the pipe body.

17. The supercharger assembly according to claim 16, wherein
the perforated plate is arranged close to the inlet joint of the mixer.
